(19) United States
(12) Patent Application Publication
(10) Pub. No.: US 2012/0023414 A1
(43) Pub. Date: Jan. 26, 2012

(54) METHOD AND APPARATUS FOR PROCESSING E-MAIL

(75) Inventors: Ji-in Nam, Seoul (KR); Moon-sang Lee, Yongin-si (KR)

(73) Assignee: SAMSUNG ELECTRONICS CO., LTD., Suwon-si (KR)

(21) Appl. No.: 13/092,428

(22) Filed: Apr. 22, 2011

(30) Foreign Application Priority Data
Jul. 23, 2010 (KR) 10-2010-0071607

(51) Int. Cl. G06F 3/048

(52) U.S. Cl. 715/752

(57) ABSTRACT

A method of processing a reply to a received e-mail is provided. When a plurality of messages are contained in a received e-mail, the plurality of messages are divided into a plurality of groups, and the plurality of messages are output according to the groups.

### CROSS-REFERENCE TO RELATED PATENT APPLICATION

This application claims priority from Korean Patent Application No. 10-2010-0071607, filed on Jul. 23, 2010, in the Korean Intellectual Property Office, the disclosure of which is incorporated herein in its entirety by reference.

### BACKGROUND

1. Field

Methods and apparatuses consistent with the exemplary embodiments relate to processing e-mail, and more particularly, to methods and apparatuses for processing e-mail, by which an input window for receiving an image in response to a request to write a reply to an e-mail is formed, the image is received through the input window, an e-mail into which the image is easily inserted is generated, and when an e-mail includes a plurality of messages, the messages are output according to a predetermined standard.

2. Description of the Related Art

Due to developments in communication technology, mobile digital devices have been widely introduced. A user may transmit and receive e-mail to and from a terminal of another user, or may use a social network service (SNS), or the like.

A user may write a text by using a keypad, etc. of a mobile digital device, in order to write an e-mail by using the mobile digital device. However, since mobile digital devices have become increasingly miniaturized for convenience of portability, and keypads of mobile digital devices are also small, it is difficult to write text by using the mobile digital devices.

In order to easily write text by using a keypad, information to be transmitted to another user's terminal is formed in a handwritten image, instead of a text. Then, the handwritten image is attached to a message or an e-mail, and is transmitted.

FIG. 1 is a diagram for explaining a method of generating an e-mail to which a handwritten image 110 is attached, by using a mobile digital device. Referring to FIG. 1, a user generates the handwritten image 110 to be transmitted to a terminal of another user, and stores the handwritten image 110 in a predetermined path. The user manipulates the mobile digital device so as to output an e-mail writing window 120 on a screen, and selects an image file in a file selecting window 130 on which there are names of files stored in the mobile digital device. The image file that is selected by the user is inserted into a body of the e-mail 140. The user may transmit the e-mail 140 into which the image file is inserted, to the terminal of the other user.

However, in this method, the user needs to manipulate the mobile digital device many times in order to transmit an image to the terminal of the other user. Thus, there is a need for a method of easily transmitting an image to a counterpart device by using a mobile digital device.

### SUMMARY

One or more aspects of the exemplary embodiments provide methods and apparatuses for processing e-mail, by which a reply to an e-mail can be conveniently written when handwritten information is received, and when an e-mail includes a plurality of messages, the messages are output according to a predetermined standard.

According to an aspect of the exemplary embodiments, there is provided a method of processing e-mail, the method including receiving a request to write a reply to a received e-mail; generating an empty file in response to the request; storing an image in the empty file, and generating an image file; and generating the reply including the image file.

The method may further include outputting an image input window for receiving information to be stored in the empty file; and receiving handwritten information from a user through the image input window, wherein the generating of the image file includes storing the handwritten information in the empty file, and generating the image file.

According to another aspect of the exemplary embodiments, there is provided an apparatus for processing e-mail, the apparatus including a user interface (UI) for receiving a request to write a reply to a received e-mail; and a controller for generating an empty file in response to the request, storing an image in the empty file, generating an image file, and generating the reply including the image file.

The apparatus may further include a screen for outputting an image input window for receiving information to be stored in the empty file, wherein the screen may output the image input window, and the UI receives handwritten information from a user, and wherein the controller may store the handwritten information in the empty file, and generate the image file.

According to another aspect of the exemplary embodiments, there is provided a method of processing e-mail, the method including, when a plurality of messages are contained in a text of a received e-mail, arranging the plurality of messages according to a predetermined standard; and outputting at least one message from among the plurality of messages, according to an order in which the plurality of messages are arranged.

The predetermined standard may include at least one of a point of time when a corresponding message is received, a type of file contained in the corresponding message, and whether a message contains a predetermined keyword.

The type of file may be identified by using a file extension of a file inserted into the corresponding message.

The method may further include receiving a keyword, wherein the predetermined standard is whether the corresponding message contains the keyword or a portion of the keyword.

The outputting may include outputting only some of the plurality of messages.

The outputting may include identifying a valid region of the at least one message; generating an output image in consideration of the valid region and a size of a screen on which the at least one message is to be output; and outputting the output image.

According to another aspect of the exemplary embodiments, there is provided an apparatus for processing e-mail, the apparatus including an output unit, wherein when a plurality of messages are contained in a received e-mail, arranging the plurality of messages according to a predetermined standard, and outputting at least one message from among the plurality of messages according to an order in which the plurality of messages are arranged.

According to another aspect of the exemplary embodiments, there is provided a method of processing e-mail, the method including when a plurality of messages are contained in a received e-mail, dividing the plurality of messages into a plurality of groups, and outputting the plurality of messages according to the groups.

The dividing may include dividing the plurality of messages on a group-by-group basis, or on a predetermined number of images-by-images basis, wherein the group includes at least one message.

The dividing may include, when the plurality of messages includes text, dividing the text on a predetermined number of words-by-words basis, or on a predetermined number of characters-by-characters basis.

The outputting may include identifying a valid region of the plurality of messages; generating an output image in consideration of the valid region and a size of a screen on which the plurality of message are to be output, and outputting the output image.

According to another aspect of the exemplary embodiments, there is provided an apparatus for processing e-mail, the apparatus including an output unit, which when a plurality of messages are contained in a received e-mail, divides the plurality of messages into a plurality of groups, and outputting the plurality of messages according to the groups.

According to another aspect of the exemplary embodiments, there is provided a computer readable recording medium having embodied thereon a program for executing a method of processing e-mail, the method including receiving a request to write a reply to a received e-mail; generating an empty file, in response to the request; storing an image in the empty file; generating an image file, and generating the reply including the image file.

According to another aspect of the exemplary embodiments, there is provided a computer readable recording medium having recorded thereon a program for executing a method of processing e-mail, the method including when a plurality of messages are contained in a received e-mail, arranging the plurality of messages according to a predetermined standard, and outputting at least one message from among the plurality of messages according to an order in which the plurality of messages are arranged.

According to another aspect of the exemplary embodiments, there is provided a computer readable recording medium having embodied thereon a program for executing a method of processing e-mail, the method including when a plurality of messages are contained in a received e-mail, dividing the plurality of messages into a plurality of groups, and outputting the plurality of messages according to the groups.

### BRIEF DESCRIPTION OF THE DRAWINGS

The above and other aspects will become more apparent by describing in detail exemplary embodiments thereof with reference to the attached drawings in which:

FIG. 1 is a diagram for explaining a method of generating an e-mail to which a handwritten image is attached, by using a mobile digital device;

FIG. 2 is a block diagram of a user terminal, according to an exemplary embodiment;

FIG. 3 is a diagram of source code in which an empty file path is inserted into a hypertext markup language (HTML) document, according to an exemplary embodiment;

FIG. 4 is a diagram for explaining a method of attaching a handwritten image to an e-mail, according to an exemplary embodiment;

FIGS. 5 and 6 are diagrams for explaining a method of outputting an e-mail into which an image is inserted, onto a screen, according to an exemplary embodiment;

FIG. 7 is a diagram for explaining a method of adjusting a size of a received image inserted into a received e-mail according to a size of a screen, and outputting the image, according to an exemplary embodiment; and

FIG. 8 is a flowchart of a method of processing an e-mail, according to an exemplary embodiment.

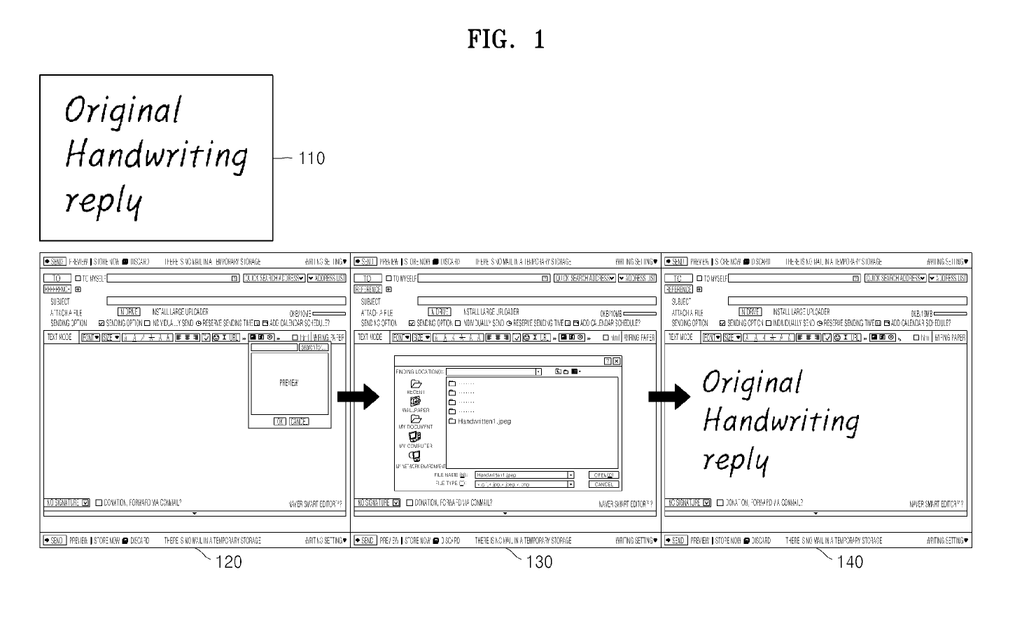

### DETAILED DESCRIPTION OF THE EXEMPLARY EMBODIMENTS

The inventive concepts will now be described more fully with reference to the accompanying drawings, in which exemplary embodiments are shown.

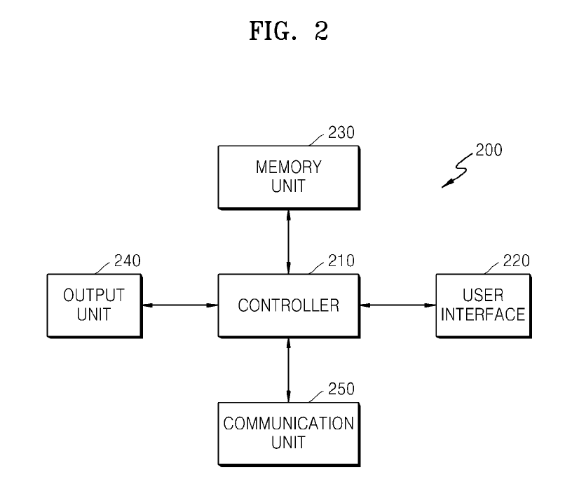

FIG. 2 is a block diagram of a user terminal 200, according to an exemplary embodiment. The user terminal 200 may be a device for writing an e-mail, and transmitting and receiving the e-mail to and from a terminal (not shown) of another user via a network, and may be, for example, a personal digital assistant (PDA), a portable multimedia player (PMP), or a smart phone.

Referring to FIG. 2, the user terminal 200 includes a controller 210, a user interface (UI) 220, a memory unit 230, an output unit 240, and a communication unit 250.

The UI 220 interfaces with a user. The user interface 220 receives instructions, characters, numbers or sound information from the user, and transmits the instructions, characters, numbers or sound information to the controller 210. The UI 220 may be a physical transducer such as a keyboard, a mouse, a touch pad, a touch screen, or a microphone.

According to an exemplary embodiment, the user may request to write a reply to the e-mail received by the user terminal 200 by using the UI 220. In addition, the user may request transmission of the reply by using the UI 220.

When the UI 220 is a touch screen, the user may generate and input handwritten information to the UI 220 by using a stylus or a finger. In addition, if the received e-mail includes a plurality of images, the user may touch and drag the images on the UI 220 up, down, right or left to output a next or previous image of a current image by the output unit 240, that is, the touch screen, from among the images contained in a received E-image.

The memory unit 230 stores programs for performing various functions of the user terminal 200. The memory unit 230 may be a speed main memory such as a random access memory (RAM), or a read only memory (ROM), a long-term auxiliary memory such as a floppy disk, a hard disk, a tape, a CD-ROM, or a flash memory, and a storage device for storing data using an electric, magnetic or optical storage medium, or the like.

When the user requests to write the reply to the received e-mail by using the UI 220, the controller 210 may generate an empty file in the memory unit 230. The empty file has a name, but the size of the empty file is 0. According to an exemplary embodiment, the empty file may be a file having an image file extension. The image file extension may be, for example, gif, jpg, jpeg, or bmp.

An image that is input by the user through an image input window may be stored in the empty file. When a file is generated by storing the image in the empty file, the file may then have a size that is greater than 0.

The output unit 240 may output an overall state of the user terminal 200, may perform an operation requested by the user, and may output a result. The output unit 240 may include a screen for outputting a graphic element such as a video signal and/or a menu or script. In addition, the output unit 240 may include a speaker (not shown) for outputting an audio signal.

The communication unit 250 may transmit and receive a media signal to and from a server (not shown) or various user terminals (not shown) through a wired or wireless network. When the communication unit 250 uses a wireless communication method, the communication unit 250 may include a wireless signal transceiver (not shown), a baseband processor (not shown), and a link controller (not shown). The baseband processor and the link controller are connected to the controller 210 by a host control interface (HCI), and transmit and receive a control command and data by transmitting and receiving a HCI packet. The wireless communication method may use a wireless local area network (WLAN), bluetooth, zigbee, wireless broadband (WiBro), wireless fidelity (Wi-Fi), or the like.

The controller 210 may control a whole operation of the user terminal 200 so as to generate the reply. The controller 210 may include an arithmetic logic unit (ALU) for performing calculation, and a register for temporally storing data and a command.

When the user requests to write the reply by using the UI 220, the controller 210 may automatically generate the empty file in the memory unit 230. The controller 210 may control the output unit 240 so that an image input window may be output on the output unit 240. The controller 210 may add an empty file path, which is generated in a predetermined path of the memory unit 230, to a body of the reply. The e-mail may be written in a hypertext markup language (HTML) document.

The user may input a desired image to the image input window output on the output unit 240 by using the UI 220, and a finger or a stylus.

After the user inputs the image, when the user requests transmission of the reply by using the UI 220, the controller 210 may store the input image in the empty file generated in the memory unit 230 so as to generate an image file. In this case, a path for storing the image file may be the same as a path for storing the empty file.

The controller 210 may control the communication unit 250 so as to transmit the reply to the terminal of the other user. In this case, since the empty file path is stored in the body of the reply, the image file generated in the empty file path is contained in the text of the reply, and is transmitted to the terminal of the other user.

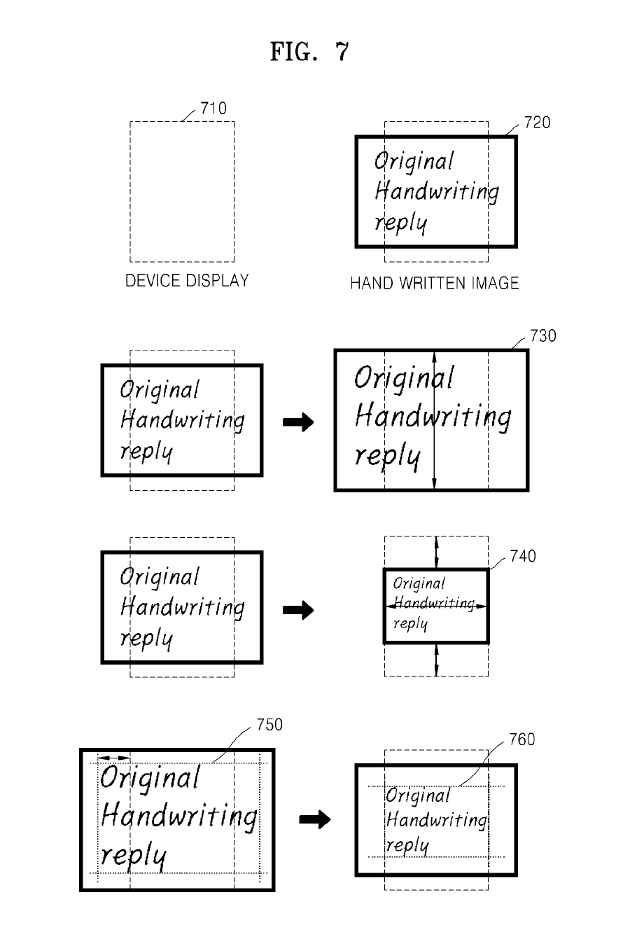

Hereinafter, an image contained in the received e-mail is referred to as a receiving image. If the body of the received e-mail includes a plurality of receiving images, the controller 210 may adjust the size of the receiving images by using the size of the output unit 240, that is, a screen, may distinguish a valid region in the receiving images the size of which is adjusted, may adjust the size of the valid region, and may generate an output image. The controller 210 may output the output image instead of the receiving image on the output unit 240, which will be described in detail later, with reference to FIG. 7.

According to the present exemplary embodiment, when the user requests to write the reply to the received e-mail, the empty file is automatically generated, and simultaneously, the image input window is output on the screen. The image input window may receive a user's input.

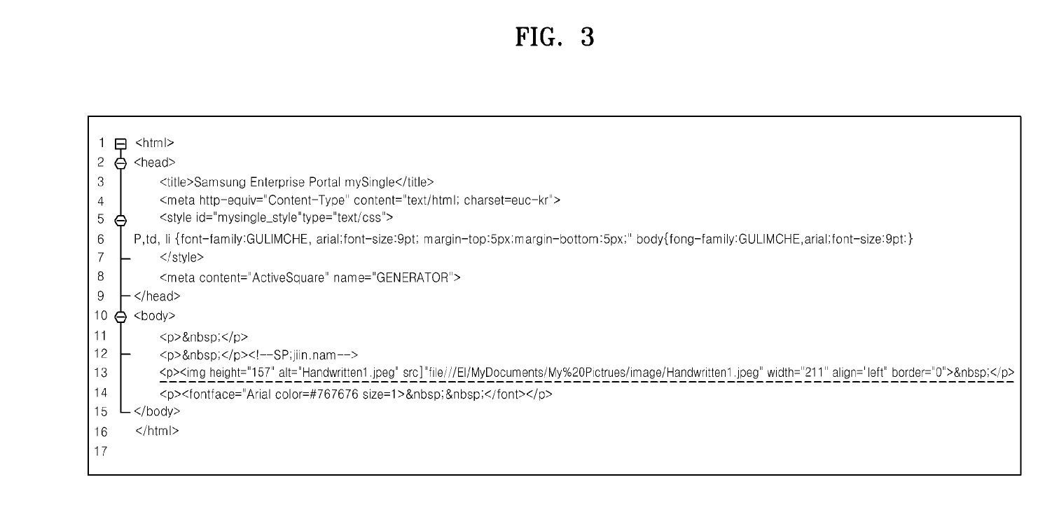

FIG. 3 is a diagram of source code in which an empty file path is inserted into a HTML document, according to an exemplary embodiment.

While a user reads a received e-mail, when the user requests to write a reply to the received e-mail by using the UI 220, the user terminal 200 generates an empty file in a predetermined path of the memory unit 230. The user terminal 200 inserts a location in which the empty file is generated, that is, the empty file path, into a body of the reply, for example, the HTML document.

Referring to FIG. 3, the empty file path inserted into the HTML document is indicated by dotted lines. In FIG. 3, the empty file is stored in a folder ‘My Documents’ of an E-drive and is given a file name ‘Handwritten1. jpeg’.

The user terminal 200 generates the empty file, and simultaneously outputs the image input window on the output unit 240 so as to receive handwritten information from the user. When the user terminal 200 receives a request for transmission of the reply from the user, the user terminal 200 stores the handwritten information in the empty file, and generates the image file. In this case, in FIG. 3, the image file is stored in the empty file path.

According to the present exemplary embodiment, when the user requests generation of the reply, the empty file is automatically generated in a predetermined location, and simultaneously the location in which the empty file is generated is inserted into the body of the reply.

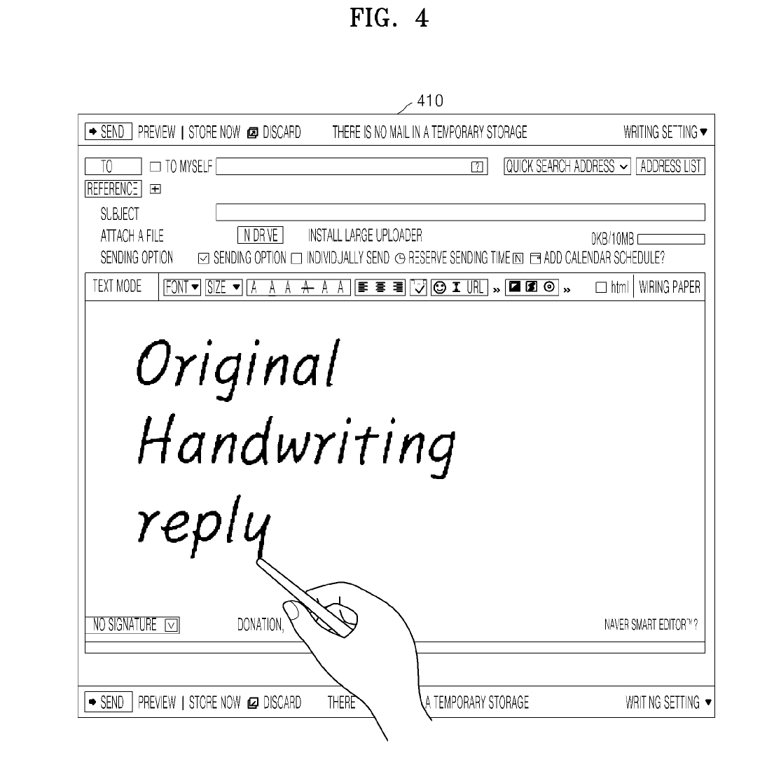

FIG. 4 is a diagram for explaining a method of attaching a handwritten image to an e-mail, according to an exemplary embodiment.

Referring to FIG. 4, when a user requests generation of an e-mail by using the UI 220, a body of e-mail 410 containing an image input window is output on the output unit 240. The user may consider the body of e-mail 410 as a drawing board, and may input a desired image on the image input window by using a finger or a stylus. When the user finishes handwriting an image, and requests transmission of the e-mail by using the UI 220, the user terminal 200 stores the image input by the user in an empty file, and generates an image file, and transmits a HTML document to which the image file is attached, to a terminal of another user through the communication unit 250.

According to the present exemplary embodiment, when the user requests to write an e-mail, the image input window is automatically output so that the user may simply input a handwritten image. Thus, the user does not go through the inconvenience of generating a handwritten image to be transmitted to the terminal of another user, storing the handwritten image in a predetermined path, calling an e-mail writing window, selecting the handwritten image that is previously stored, and then attaching the handwritten image to the e-mail.

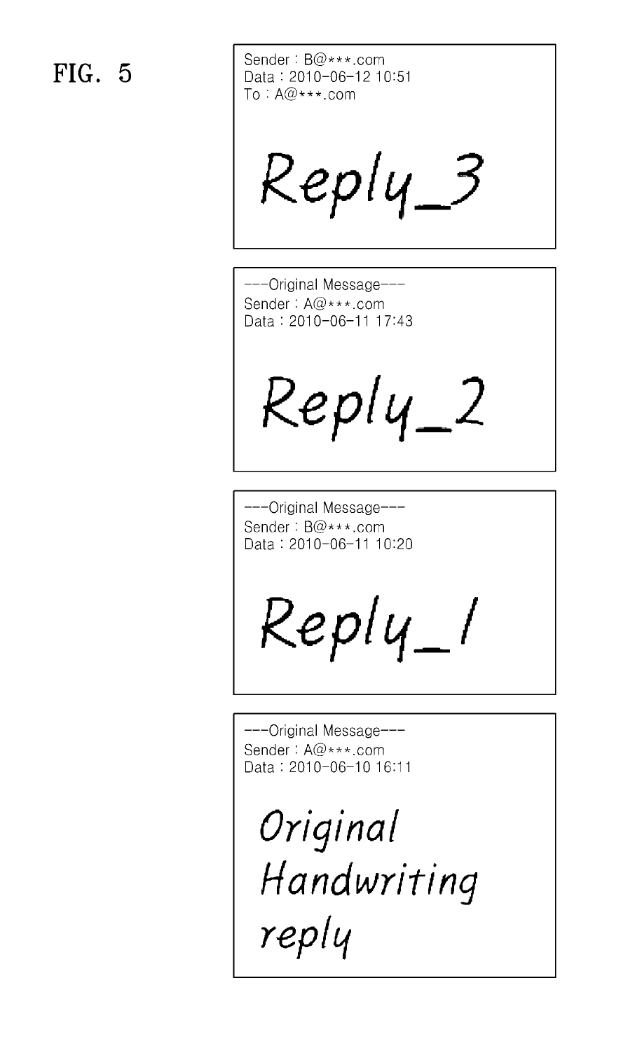

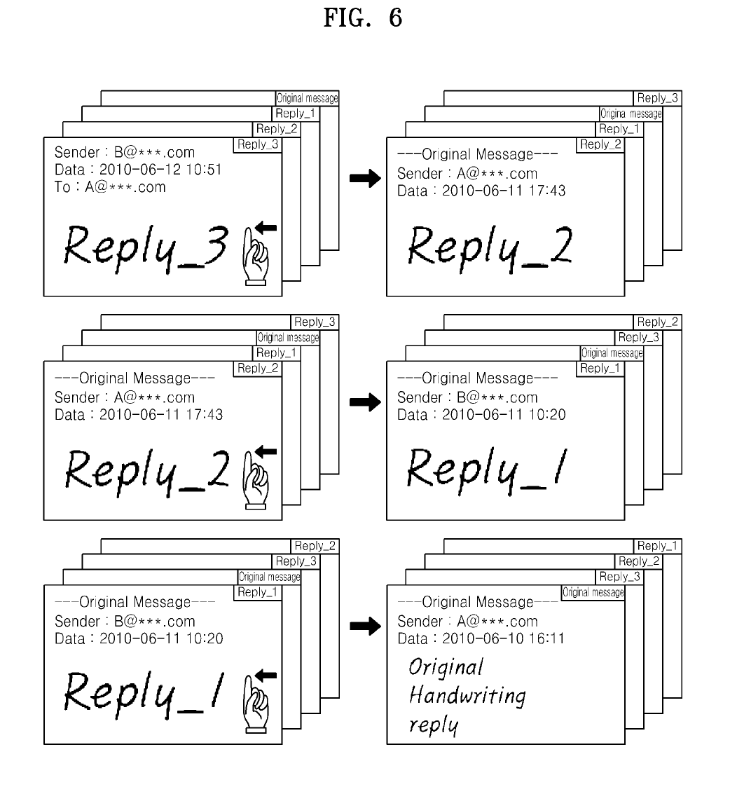

FIGS. 5 and 6 are diagrams for explaining a method of outputting an e-mail into which an image is inserted, onto a screen, according to an exemplary embodiment.

When e-mails are transmitted between a user and the same other user many times, the user may write and transmit a new e-mail, and may write and transmit a reply to a received e-mail. In addition, the user may forward an e-mail that is transmitted between the user and a third party to the other user, or may receive forwarding of an e-mail that is between the other user and a third party. In this case, a previous message that is transmitted before, and new messages may be contained in text of an e-mail.

A message may include identification information at a top of the message for identifying the message. The identification information may include at least one of a sender, a receiver, a sending date, and a subject. In order to distinguish the previous message and the new message, the identification information included in the previous message may further include an original message.

When an image is inserted into the previous e-mail that is transmitted between the user and the other user, or when the user inserts an image into a reply to the previous e-mail, a single e-mail may include a plurality of images. In addition, when an e-mail into which an image is inserted is transmitted between the counterpart and a third party, and then the counterpart inserts a new image into the e-mail, and forwards the e-mail, a body of the forwarded e-mail may include a plurality of images.

FIG. 5 shows the body of an e-mail containing a plurality of messages that are written from bottom to top in a time sequence. The image depicted at the bottom of FIG. 5 may represent a message that is written first, and the image that is depicted at the top of FIG. 5 may represent a message that is written last.

According to the present exemplary embodiment, a plurality of messages may be arranged in various orders, which may be contained in the body of the e-mail. An order in which the messages are arranged may be determined by the user by using the UI 220, or may be set as a default in the user terminal 200.

According to another exemplary embodiment, when the received e-mail includes a plurality of messages, the user terminal 200 of FIG. 2 may perform the following function.

When the received e-mail includes a plurality of messages, the output unit 240 of the user terminal 200 may output the messages included in the body of the e-mail so as to be arranged in various ways.

In this case, the user may determine an order in which the messages are arranged, by using the UI 220. Alternatively, when a plurality of messages are contained in the body of the received e-mail, an order in which the messages are arranged may be set as a default in the user terminal 200.

The output unit 240 may output the e-mail so that the messages may be arranged according to the order determined by the user, or the order set in the user terminal 200.

For example, the output unit 240 may output the body of the e-mail so that the messages may be arranged in a time sequence in which the messages are written or in a reverse order.

According to another exemplary embodiment, when the received e-mail includes a plurality of messages including various types of files, the output unit 240 may arrange the messages according to the type of file, and may output the messages in the order in which the messages are arranged. Alternatively, the messages including an image may be arranged and output in an order in which the messages are generated, or an order in which the messages are received.

According to another exemplary embodiment, when files are inserted into messages, the output unit 240 may arrange the messages according to the type of file, and may output the messages according to the order in which the messages are arranged. For example, when various files such as an image file, a moving picture file, a text file, and the like are inserted into the messages, the messages may be arranged according to file extensions of files contained in the messages, may be inserted into the body of the e-mail, and may be output according to the order in which the messages are arranged. In this case, the type of file may be identified by the file extension, or may be identified according to another standard.

The output unit 240 may output only a message including a file that is selected from among various types of files included in messages, such as an image file, a moving picture file, a text file, and the like.

In addition, the output unit 240 may filter and output only files that are selected from among various types of files included in the messages.

According to another exemplary embodiment, when the text of the e-mail contains a plurality of images, the output unit 240 may output each image from among a plurality of images, on a screen.

When the output unit 240 is a touch screen that may be used as the UI 220, the user may drag images on the touch screen up, down, right or left. In this case, the output unit 240 may output any one of a next image and a previous image of the current image from among a plurality of images contained in the text of the e-mail, by dragging the images up, down, right or left.

In addition, when the user inputs a keyword by using the UI 220, the controller 210 identifies a message containing the keyword or a portion thereof, the controller 210 informs the output unit 240 about the message containing the keyword or a portion thereof, and a message that does not contain the keyword or a portion thereof. The output unit 240 may sequentially arrange messages from the message containing the keyword or a portion thereof, and may output the text of the e-mail.

For example, when the user inputs the keyword by using the UI 220, the user terminal 200 may sequentially arrange messages in the text of the e-mail, the sequence going from the message containing the most similar word to the keyword, which is determined by using pattern matching or the like, to a message that does not contain a similar word to the keyword, and may output the e-mail. In addition, only a message containing the keyword or at least a portion of the keyword may be output.

The user terminal 200 may output an entire text of the e-mail including a plurality of images on the output unit 240, as shown in FIG. 5. However, since the display of a typical mobile device generally has a small size, when an e-mail includes a plurality of images, if the user terminal 200 outputs all the images, the sizes of the images are excessively reduced, and thus the user may experience some inconvenience. Thus, the user terminal 200 may only output some images of the images on the output unit 240. In order to view handwritten information contained in the e-mail, the user may manipulate the UI 220 so that the text of the e-mail may be output from bottom to top, or from top to bottom, and may check the e-mail.

When the e-mail to be output on a screen includes a plurality of messages, the output unit 240 of the user terminal 200 may divide the messages into a plurality of groups according to a predetermined standard, and may output the messages on a group-by-group basis. For example, each message may be output on the screen, or a predetermined number of messages may be simultaneously output on the screen. In addition, the messages may be output on the screen on an image-by-image basis, or on a predetermined number of images-by-images basis.

When a message includes text, the message may be output in a predetermined range. For example, a single message may be output on a page-by-page basis, or a predetermined number of words or characters, for examples, 100 words may be output on a page-by-page basis. In addition, when a social network service (SNS) such as Facebook or Twitter is provided to the user terminal 200, a predetermined range of messages, for example, a single message, may be output on a page-by-page basis.

When a single message is output on a screen on a page-by-page basis, the user may touch and drag an image on the screen up, down, right or left so that a different image from an image that is currently output on the user terminal 200 is displayed.

When a plurality of messages are included in the text of the e-mail, if the user drags the screen in a predetermined direction, a next or previous image of the current image is output. For example, when the text of the e-mail contains messages that are arranged in a time sequence in which the messages are written or in a reverse order, if the user drags an image on the screen in a predetermined direction, the next or previous image of the current image is output.

When the body of the e-mail contains a plurality of messages that are arranged according to file extensions of the messages, or the body of the e-mail contains a plurality of messages that are sequentially arranged from a message containing the most similar word to a keyword input by the user, if the user drags an image on the screen in a predetermined direction, the next or previous image of the current image is output.

FIG. 6 shows a case where, when messages are arranged in a time sequence in which the messages are written or in a reverse order, if a user drags an image on a screen to the left by using a touch-and-drag function, a previous image of the current image is output.

According to another exemplary embodiment, the user terminal 200 may output only an image included in a message, instead of an entire message. When the user drags an image on the screen by using the touch-and-drag function, the user terminal 200 may output the next or previous image of the current image, in response to dragging.

According to the present exemplary embodiment, when the user checks the e-mail including a plurality of images, the user may use the images on an image-by image basis by using the touch-and-drag function, without scrolling an entire body of the e-mail, and thus the user may easily find and use a desired image.

FIG. 7 is a diagram for explaining a method of adjusting a size of a received image 720 inserted into a received e-mail according to a size of a screen 710, and outputting the image, according to an exemplary embodiment. In FIG. 7, the screen 710 of the output unit 240, and the received image 720 inserted into the received e-mail are illustrated in predetermined sizes.

Generally, when the size of an image to be output is different from the size of a screen of a device, the device may reduce the size of the image so that the image may be entirely output on the screen. When the size of the received image 720 is reduced so as to be entirely output within the screen 710 of the output unit 240, the received image 720 is reduced to have the same size as that of an image 740 of FIG. 7, and is output on the screen 710. Generally, since the user terminal 200 has a small size, when the received image 720 that is reduced to have the same size as that of the image 740 may be output on the user terminal 200, the user may experience inconvenience when viewing the received image 720.

Thus, according to the present exemplary embodiment, when the received image 720 is output on the screen 710, the received image 720 is resized so that it is not excessively reduced.

First, the user terminal 200 adjusts the size of the received image 720 so as not to form an extra space of the received image 720 on the screen 710. The user terminal 200 adjusts the size of the received image 720 by using horizontal and vertical lengths of the screen 710 and the received image 720.

In more detail, the user terminal 200 calculates a ratio of a horizontal length of the screen 710 to a horizontal length of the received image 720, and a ratio of a vertical length of the screen 710 to a vertical length of the received image 720. For convenience, the ratio of the horizontal length of the screen 710 to the horizontal length of the received image 720 is referred to as a first ratio, and the ratio of the vertical length of the screen 710 to the vertical length of the received image 720 is referred to as a second ratio. The user terminal 200 determines which is greater from among the first ratio and the second ratio.

In FIG. 7, the horizontal length of the received image 720 is greater than the horizontal length of the screen 710, and the vertical length of the received image 720 is smaller than the vertical length of the screen 710. Thus, the second ratio is greater than the first ratio.

The user terminal 200 adjusts the size of the received image 720 by using a greater value of the first ratio and the second ratio. That is, when the first ratio is greater than the second ratio, the user terminal 200 adjusts the horizontal length of the received image 720 so as to match the horizontal length of the screen 710. When the second ratio is greater than the first ratio, the user terminal 200 adjusts the vertical length of the received image 720 so as to match the vertical length of the screen 710. In addition, after the user terminal 200 adjusts any one of the horizontal and vertical lengths of the received image 720, the user terminal 200 adjusts the remaining length of the horizontal and vertical lengths so that a ratio between the horizontal and vertical lengths of the received image 720, the size of which is adjusted, may be the same as a ratio between the horizontal and vertical lengths of the received image 720, the size of which is not adjusted.

In FIG. 7, since the second ratio is greater than the first ratio, the user terminal 200 adjusts the vertical length of the received image 720 so as to match the vertical length of the screen 710. In addition, the user terminal 200 adjusts the horizontal length of the received image 720 by as much as the adjusted length of the vertical length of the received image 720. In this case, the received image 720 the size of which is adjusted is illustrated as an image 730 (hereinafter, referred to as the received image 720) of FIG. 7.

The user terminal 200 identifies a valid region in the received image 730. Hereinafter, a region including a graphic element such as a character or color will be referred to as a valid region, in order to distinguish the region from a non-valid region.

The user terminal 200 may distinguish a pixel including a graphic element such as a character or color from a pixel including no graphic element, by using brightness of pixels constituting an image, or RGB elements of the pixels. The user terminal 200 may realize brightness or color of each pixel from an edge of the image, and may identify a valid region having a rectangular shape, based on the outermost pixel from among pixels having various brightness or colors. In FIG. 7, the valid region 750 is shown.

The user terminal 200 adjusts the size of the valid region 750 so as to match the size of the screen 710, and generates an image to be output on the screen 710. The user terminal 200 calculates a ratio of the horizontal length of the screen 710 to the horizontal length of the valid region 750, and calculates a ratio of the vertical length of the screen 710 to the vertical length of the valid region 750. For convenience, the ratio of the horizontal length of the screen 710 to the horizontal length of the valid region 750 will be referred to as a third ratio, and the ratio of the vertical length of the screen 710 to the vertical length of the valid region 750 will be referred to as a fourth ratio. The user terminal 200 determines which is greater from among the third ratio and the fourth ratio.

In FIG. 7, the horizontal length of the valid region 750 is greater than the horizontal length of the screen 710, and the vertical length of the valid region 750 is smaller than the vertical length of the screen 710. Thus, the third ratio is smaller than the fourth ratio.

The user terminal 200 adjusts the size of the valid region 750 by using a smaller value of the third ratio and the fourth ratio. That is, when the third ratio is smaller than the fourth ratio, the user terminal 200 adjusts the horizontal length of the valid region 750 so as to match the horizontal length of the screen 710. When the fourth ratio is smaller than the third ratio, the user terminal 200 adjusts the vertical length of the valid region 750 so as to match the vertical length of the screen 710. In addition, after the user terminal 200 adjusts any one of the horizontal and vertical lengths of the valid region 750, the user terminal 200 adjusts the remaining length of the horizontal and vertical lengths so that a ratio between horizontal and vertical lengths of the valid region 750, the size of which is adjusted, may be the same as a ratio between the horizontal and vertical lengths of the valid region 750, the size of which is not adjusted.

In FIG. 7, since the third ratio is smaller than the fourth ratio, the user terminal 200 adjusts the horizontal length of the valid region 750 so as to match the horizontal length of the screen 710. In addition, the user terminal 200 adjusts the vertical length of the valid region 750 by as much as the adjusted length of the horizontal length of the valid region 750, and generates an output image. The output image is shown as 760 of FIG. 7. In FIG. 7, when the size of the output image 760 is compared to the image 740, a graphic element such as a character or figure of the output image 760, which is output on the screen 710, is larger than in the image 740.

Thus, according to the present exemplary embodiment, when an image inserted into an e-mail is output on a screen, the size of the image may be adjusted according to the size of the screen, and the image may be output.

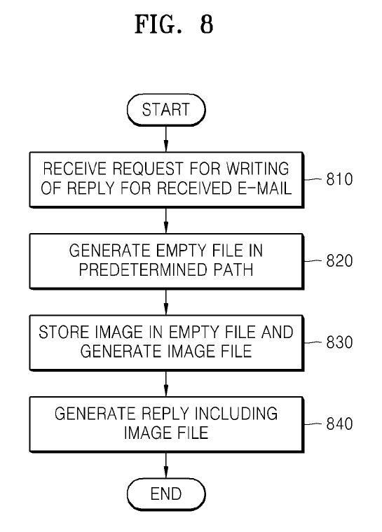

FIG. 8 is a flowchart of a method of processing e-mail, according to an exemplary embodiment.

Referring to FIG. 8, the user terminal 200 receives an e-mail, and receives a request to write a reply to the received e-mail (operation 810). The user terminal 200 generates an empty file in a predetermined path, in response to the request to write a reply to the received e-mail (operation 820).

The user terminal 200 may add the path in which the empty file is stored, to a HTML document. The user terminal 200 outputs an image input window for receiving information to be stored in the empty file, on a screen. The user terminal 200 receives handwritten information from the user through the image input window.

When the user terminal 200 receives a request for transmission of the reply from the user, the user terminal 200 stores the handwritten information in the empty file, and generates an image file (operation 830). In addition, the user terminal 200 generates the reply including the image file (operation 840).

As described above, according to the exemplary embodiments, when a received image is output on a screen, the size of the received image is adjusted, a valid region is identified in the received image the size of which is adjusted, the size of the valid region is adjusted so as to match the size of the screen, and the received image is input on the screen. Thus, an enlarged graphic element included in the received image may be output on the screen if possible.

The inventive concepts can also be embodied as computer readable codes on a computer readable recording medium. The computer readable recording medium may be any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion. Also, functional programs, codes, and code segments for accomplishing the exemplary embodiments can be easily construed by programmers of ordinary skill in the art to which the exemplary embodiments pertain.

While the inventive concepts have been particularly shown and described with reference to exemplary embodiments thereof, it will be understood by those of ordinary skill in the art that various changes in form and details may be made therein without departing from the spirit and scope of the exemplary embodiments as defined by the following claims.

What is claimed is:

1. A method of processing a reply to a received e-mail, the method comprising:
receiving a request to write the reply to the received e-mail;
generating an empty file, in response to the request;
storing an image in the empty file, and generating an image file; and
generating the reply comprising the image file.

2. The method of claim 1, further comprising:
outputting an image input window for receiving information to be stored in the empty file; and
receiving handwritten information from a user through the image input window,
wherein the generating of the image file comprises storing the handwritten information in the empty file, and generating the image file.

3. An apparatus for processing a reply to a received e-mail, the apparatus comprising:
a user interface (UI) for receiving a request to write the reply to the received e-mail; and
a controller which generates an empty file in response to the request, stores an image in the empty file, generates an image file, and generates the reply comprising the image file.

4. The apparatus of claim 3, further comprising a screen which outputs an image input window which receives information to be stored in the empty file,
wherein the screen outputs the image input window, and the UI receives handwritten information from a user, and
wherein the controller stores the handwritten information in the empty file, and generates the image file.

5. A method of processing e-mail, the method comprising:
receiving the e-mail;
when a plurality of messages are contained in a text of the received e-mail, arranging the plurality of messages according to a predetermined standard; and
outputting at least one message from among the plurality of messages, according to an order in which the plurality of messages are arranged.

6. The method of claim 5, wherein the predetermined standard comprises at least one of a point of time when a corresponding message is received, a type of file contained in the corresponding message, and whether a message contains a predetermined keyword.

7. The method of claim 6, wherein the type of file is identified by using a file extension of a file inserted into the corresponding message.

8. The method of claim 5, further comprising receiving a keyword,
wherein the predetermined standard is whether the corresponding message contains the predetermined keyword or a portion of the predetermined keyword.

9. The method of claim 5, wherein the outputting comprises outputting only some of the plurality of messages.

10. The method of claim 5, wherein the outputting comprises:
identifying a valid region of the at least one message;
generating an output image in consideration of the valid region and a size of a screen on which the at least one message is to be output; and
outputting the output image.

11. An apparatus for processing e-mail, the apparatus comprising:
an output unit, wherein when a plurality of messages are contained in a received e-mail, arranges the plurality of messages according to a predetermined standard, and outputs at least one message from among the plurality of messages according to an order in which the plurality of messages are arranged.

12. The apparatus of claim 11, wherein the predetermined standard comprises at least one of a point of time when a corresponding message is received, a type of file contained in the corresponding message, and whether a message contains a predetermined keyword.

13. The apparatus of claim 12, wherein the type of file is identified by using a file extension of a file inserted into the corresponding message.

14. The apparatus of claim 11, further comprising an input unit for receiving a keyword,
wherein the predetermined standard is whether the corresponding message contains the predetermined keyword or a portion of the predetermined keyword.

15. The apparatus of claim 11, wherein the output unit outputs only some of the plurality of messages.

16. The apparatus of claim 11, wherein the output unit identifies a valid region of the at least one message, generates an output image in consideration of the valid region and a size of a screen on which the at least one message is to be output, and outputs the output image.

17. A method of processing e-mail, the method comprising:
when a plurality of messages are contained in a received e-mail, dividing the plurality of messages into a plurality of groups; and
outputting the plurality of messages according to the plurality of groups.

18. The method of claim 17, wherein the dividing comprises dividing the plurality of messages based on at least one of a group-by-group basis, and a predetermined number of images-by-images basis, wherein the group comprises at least one message.

19. The method of claim 17, wherein the dividing comprises, when the plurality of messages comprises text, dividing the text based on at least one of a predetermined number of words-by-words basis, and a predetermined number of characters-by-characters basis.

20. The method of claim 17, wherein the outputting comprises:
identifying a valid region of the plurality of messages;
generating an output image in consideration of the valid region and a size of a screen on which the plurality of message are to be output; and
outputting the output image.

21. An apparatus for processing e-mail, the apparatus comprising:
an output unit, which, when a plurality of messages are contained in a received e-mail, divides the plurality of messages into a plurality of groups, and outputs the plurality of messages according to the groups.

22. The apparatus of claim 21, wherein the output unit divides the plurality of messages based on at least one of a group-by-group basis, and a predetermined number of images-by-images basis, wherein a group comprises at least one message.

23. The apparatus of claim 21, wherein, when the plurality of messages comprises text, the output units divides the text based on at least one of a predetermined number of words-by-words basis, and a predetermined number of characters-by-characters basis.

24. The apparatus of claim 21, wherein the output units identifies a valid region of the plurality of messages, generates an output image in consideration of the valid region and a size of a screen on which the plurality of messages are to be output, and outputs the output image.

25. A computer readable recording medium having embodied thereon a program for executing a method of processing a reply to a received e-mail, the method comprising:
receiving a request to write the reply to the received e-mail;
generating an empty file, in response to the request;
storing an image in the empty file, and generating an image file; and
generating the reply comprising the image file.

26. A computer readable recording medium having embodied thereon a program for executing a method of processing e-mail, the method comprising:
when a plurality of messages are contained in a received e-mail, arranging the plurality of messages according to a predetermined standard; and
outputting at least one message from among the plurality of messages, according to an order in which the plurality of messages are arranged.

27. A computer readable recording medium having embodied thereon a program for executing a method of processing e-mail, the method comprising:
when a plurality of messages are contained in a received e-mail, dividing the plurality of messages into a plurality of groups; and
outputting the plurality of messages according to the groups.
